(19) United States
(12) Patent Application Publication
(10) Pub. No.: US 2013/0042433 A1
(43) Pub. Date: Feb. 21, 2013

(54) CORK HANDLE

(71) Applicant: CHIE-CHIUN WANG, New Taipei (TW)

(72) Inventor: CHIE-CHIUN WANG, New Taipei (TW)

(21) Appl. No.: 13/212,173

(22) Filed: Aug. 17, 2011

(51) Int. Cl. B25G 1/00

(52) U.S. Cl. 16/110.1

(57) ABSTRACT

A cork handle used in a kitchen contains an extension made of a traditional material and including at least one cork member; wherein the extension includes at least one receiving groove; at least one cork member is retained in the receiving groove and exposes outsides the receiving groove.

### BACKGROUND OF THE INVENTION

1. Field of the Invention

The present invention relates to a handle, and more particularly to a cork handle used in a kitchen.

2. Description of the Prior Art

A conventional handle used in kitchenware is made of wood or plastic material, but such a conventional handle still has the following defects as follows:

1. The handle made of wood is easy to generate moulds in a wet condition and is hard to be scraped easily.

2. If the handle is made of plastic or metal material, it is easy to conduct heat to scald a user.

3. If the handle is made of plastic or metal material, it is easy to hurt user because the hand is slippery.

4. The wooden handle is not thermostable to inflame easily.

The present invention has arisen to mitigate and/or obviate the afore-described disadvantages.

### SUMMARY OF THE INVENTION

The primary object of the present invention is to provide a cork handle used in a kitchen that is capable of preventing from moulds generating in a wet condition and abrasion, friction and deformation.

Furthermore object of the present invention is to provide a cork handle used in a kitchen that is rough to be held and operated by a user easily and is light, thin, and thermostable to prevent from inflammation.

Another object of the present invention is to provide a cork handle used in a kitchen that is made of wasted wood to obtain an environmental protection.

To obtain the above objectives, a cork handle used in a kitchen provided by the present invention contains:

an extension made of a traditional material and including at least one cork member;

wherein the extension includes at least one receiving groove; at least one cork member is retained in the receiving groove and exposes outsides the receiving groove.

### BRIEF DESCRIPTION OF THE DRAWINGS

FIG. 1 is a perspective view showing the assembly of a cork handle used in a kitchen according to a first embodiment of the present invention;

FIG. 2 is a perspective view showing the exploded components of the cork handle used in the kitchen according to the first embodiment of the present invention;

FIG. 3 is a perspective view showing the assembly of a cork handle used in a kitchen according to a second embodiment of the present invention;

FIG. 4 is a perspective view showing the exploded components of the cork handle used in the kitchen according to the second embodiment of the present invention;

FIG. 5 is a perspective view showing the assembly of a cork handle used in a kitchen according to a third embodiment of the present invention;

FIG. 6 is a perspective view showing the exploded components of the cork handle used in the kitchen according to the third embodiment of the present invention;

FIG. 7 is a perspective view showing the assembly of a cork handle used in a kitchen according to a fourth embodiment of the present fourth invention;

FIG. 8 is a perspective view showing the exploded components of the cork handle used in the kitchen according to the fourth embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

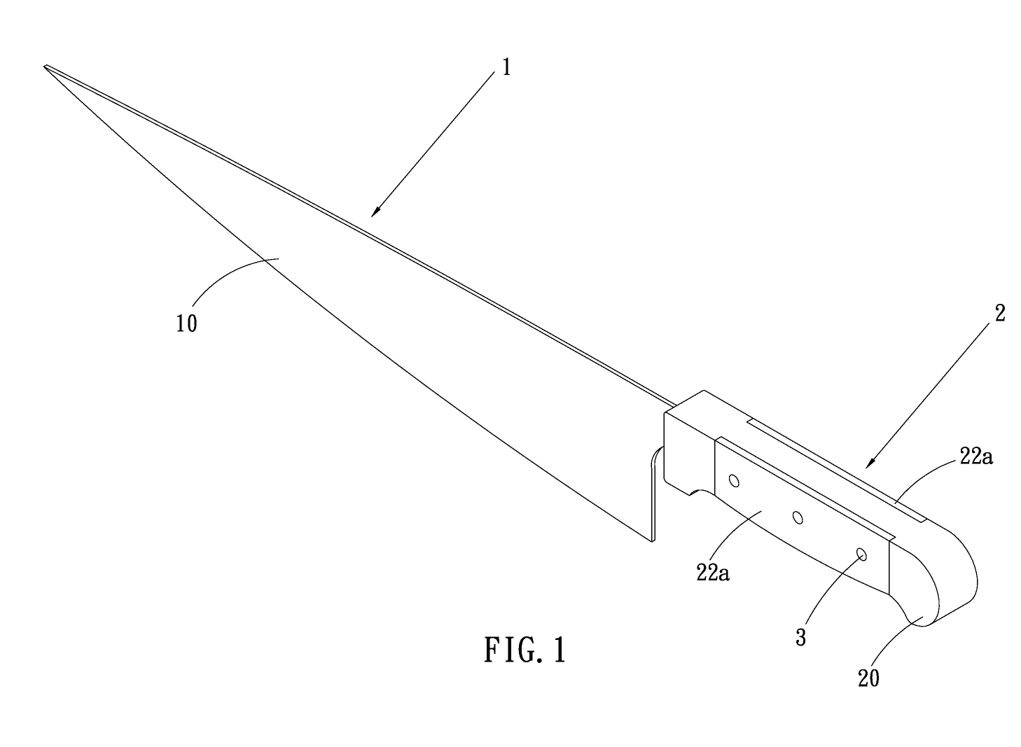

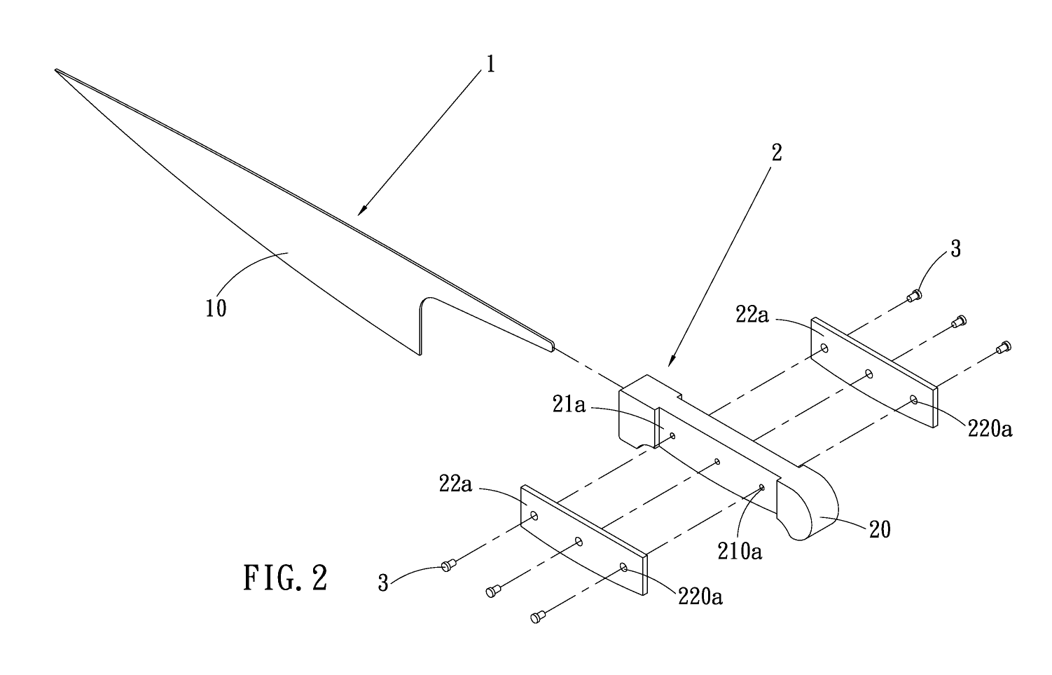

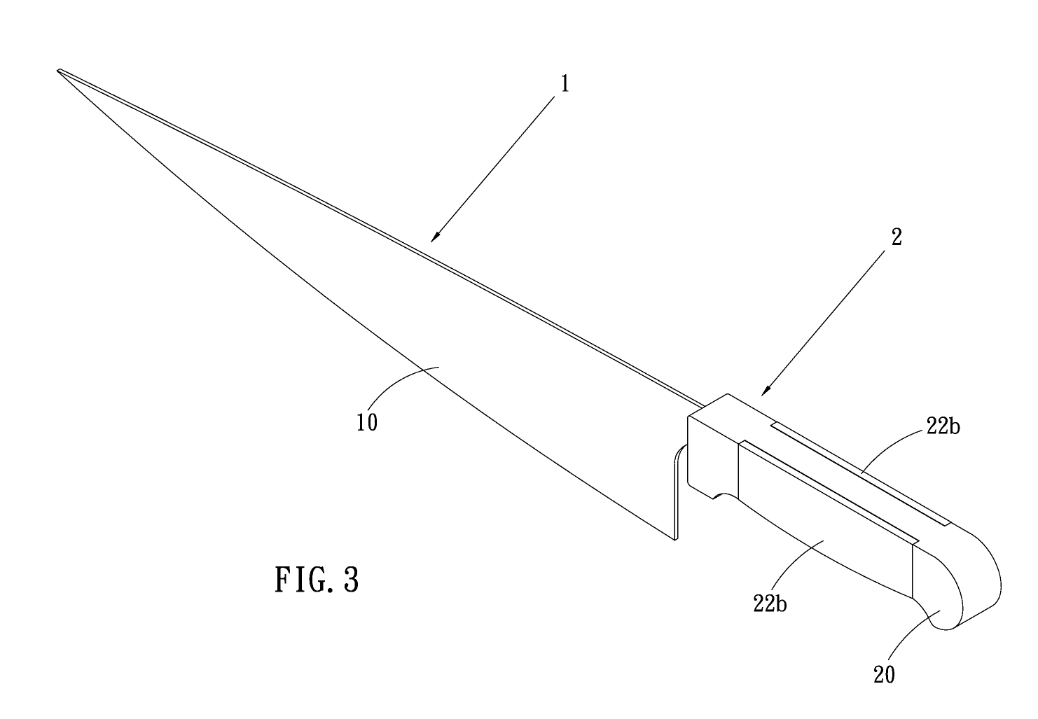

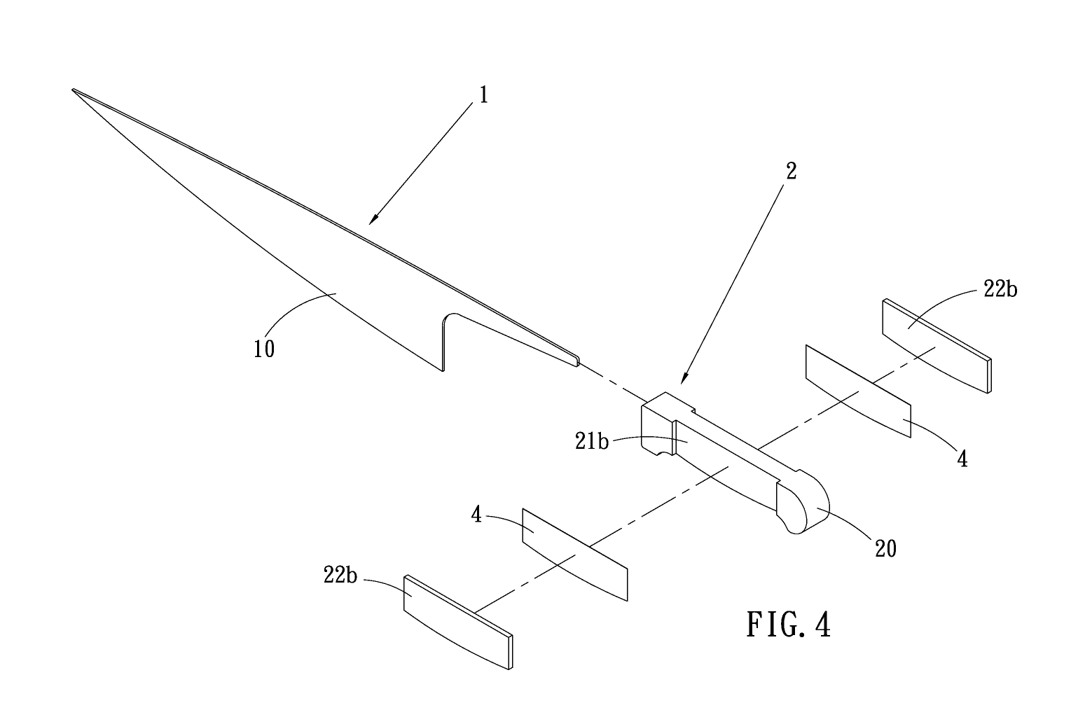

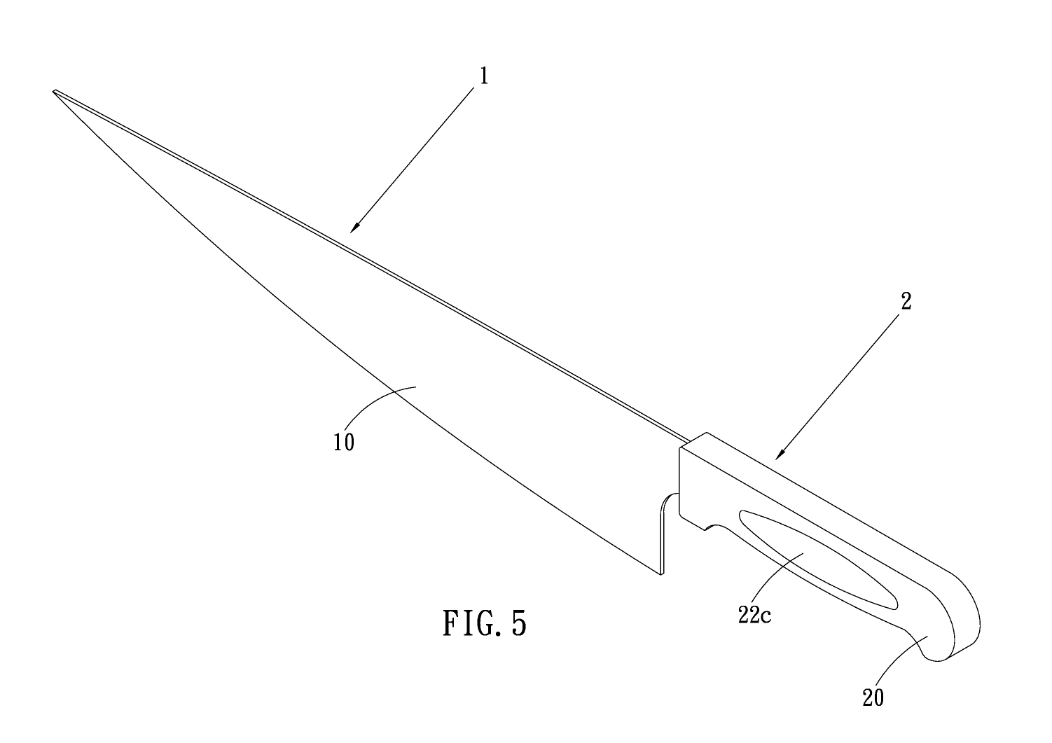

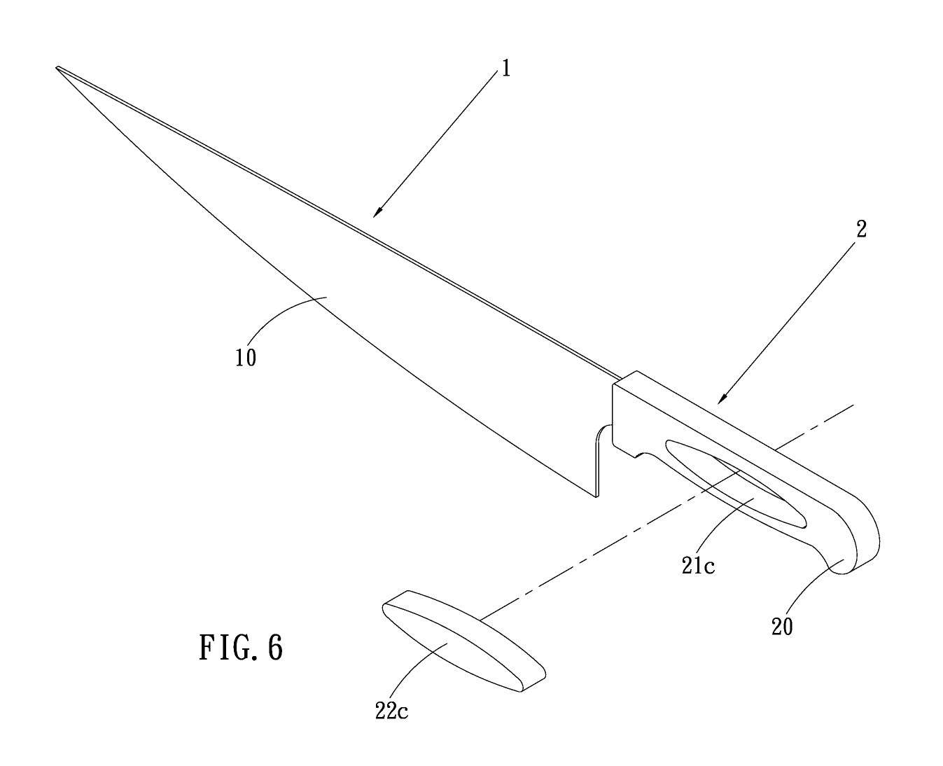

With reference to FIGS. 1-6, a cork handle according to a first embodiment of the present invention is used on a kitchen knife but not be limited to use in a kitchen.

The cork handle used on the kitchen knife includes an end portion having a connecting fulcrum to connect with a front segment 1 which is used as a cutting blade. The front segment 1 is made of metal material, such as iron or steel, and includes a sharp cutting portion 10 to cut an object.

The cork handle 2 is provided to be held by a user, wherein the cork handle 2 includes an extension 20 made of wood, plastic or metal material, and the extension 20 includes at least one receiving groove 21a, 21b or 21c and at least one cork member 22a, 22b or 22c fixed in the receiving groove 21a, 21b or 21c, the cork member 22a, 22b or 22c exposes outside the receiving groove 21a, 21b or 21c.

In the first embodiment, the cork handle 2 includes the extension 20 which is elongated, and the extension 20 includes the receiving groove 21a formed in a recessed area of each of two sides thereof, the receiving groove 21a includes a plurality of holes 210a arranged on an inner surface thereof; and each of two cork members 22a is formed in a thin piece shape and includes a number of orifices 220a disposed thereon relative to the holes 210a of the receiving groove 21a so as to be retained in the receiving groove 21a to form the cork handle 2; a plurality of fixing elements 3 to be locked in the holes 210a of the receiving groove 21a through the orifices 220a individually so that the cork members 22a are fixed in the receiving groove 21a to form the cork handle 2.

A cork handle 2 according to a second embodiment of the present invention comprises an elongated extension 20, and the elongated extension 20 includes two receiving grooves 21b formed in two recessed areas of two sides thereof individually, two cork members 22b are formed in a thin piece shape and retained in the two receiving grooves 21b respectively, two adhering pieces 4, each can be a double-sided adhesive, located between an inner surface of the receiving groove 21b and the cork member 22b to adhere the cork member 22b in the receiving groove 21b, thus forming the cork handle 2.

The cork members 22a, 22b are retained in the receiving grooves 21a, 21b respectively. Furthermore, the receiving grooves 21a, 21b include two peripheral walls extending toward two central positions thereof individually to form a decreasingly conical space; and the cork members 22a, 22b include two peripheral walls tilting outward to form a wedge. Thereby, the cork members 22a, 22b are respectively retained in the receiving grooves 21a, 21b tightly.

A cork handle 2 according to a third embodiment of the present invention comprises an elongated extension 20, and the elongated extension 20 includes an oblong receiving groove 21c formed on a middle section thereof, a cork member 22c formed in an oblong shape and retained in the receiving groove 21c, thus forming the cork handle 2.

After the cork handle 2 is formed, it is hardened in a pressurizing and heating manner to form an integral structure. Besides, the cork members 22a, 22b, 22a are connected with the extension 20 in a retaining, adhering, riveting, or screwing manner.

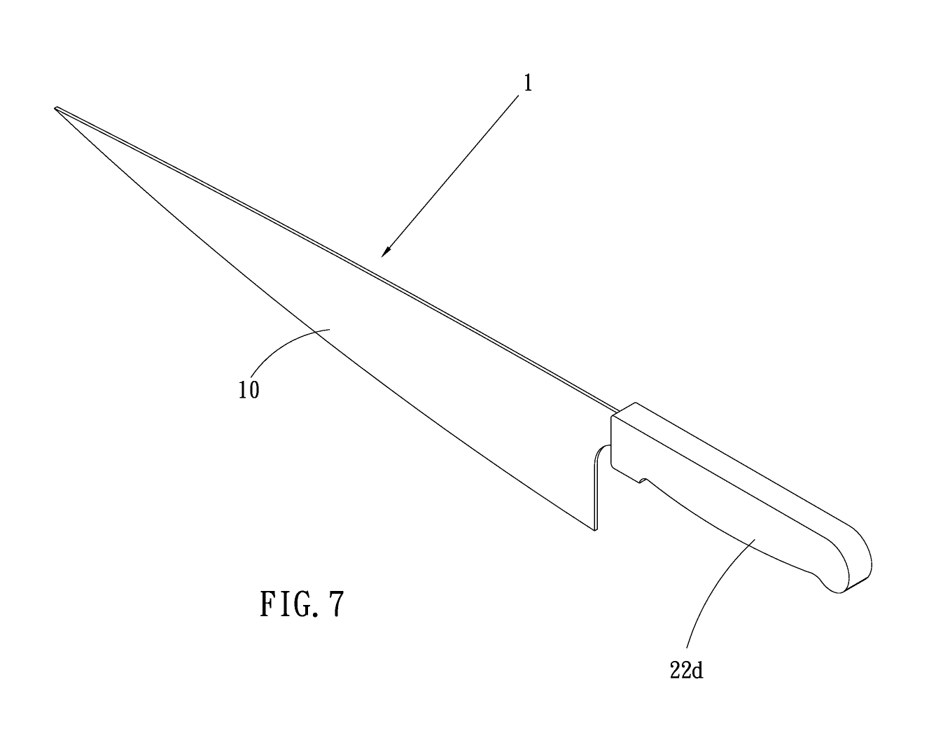

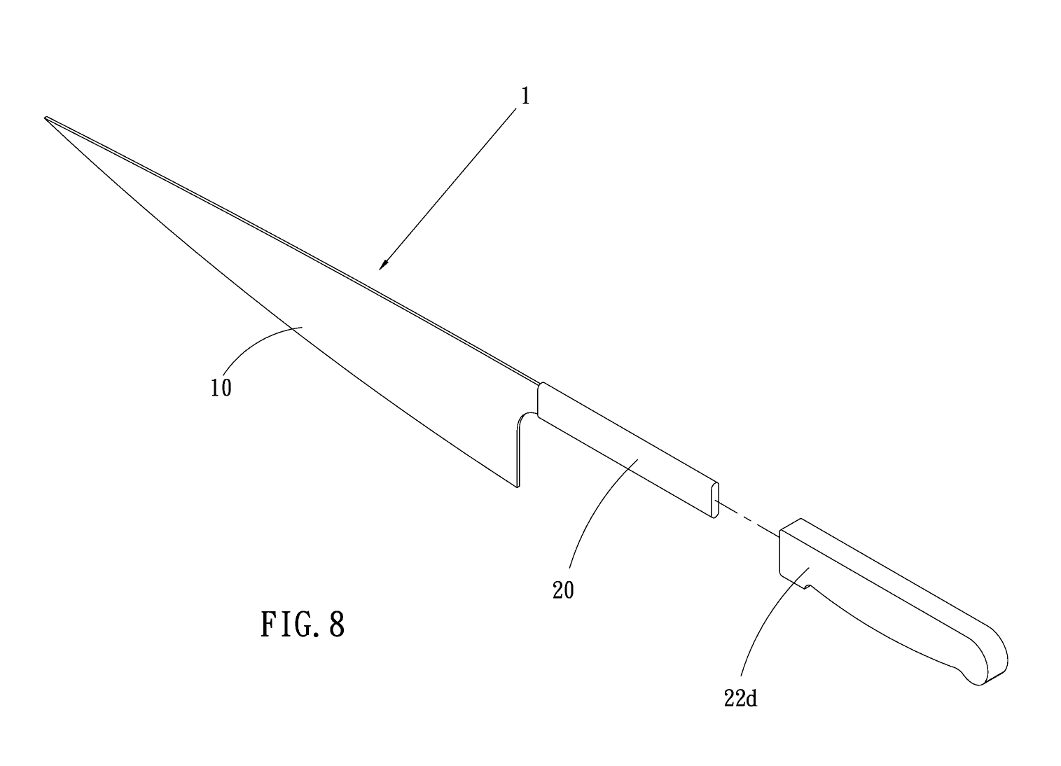

The cork members are fixed on the extensions 20 but not being limited to match with the receiving grooves 21a, 21b, 21c. As illustrated in FIGS. 7 and 8, a cork handle 2 according to a fourth embodiment of the present invention comprises a flat extension 20, a cork member 22d formed in a handle shape and including an aperture formed on one side of thereof relative to the extension 20. Thereby, the cork member 22d is fitted with the extension 20 by using the aperture. The cork members 22a, 22b, 22c, 22d are applied on the cork handle 2 to keep advantages of traditional wood, plastic or metal material. In addition, the cork handle is not limited to use on a tool but on various dining utensils or cooking utensils.

While we have shown and described various embodiments in accordance with the present invention, it is clear to those skilled in the art that further embodiments may be made without departing from the scope of the present invention.

What is claimed:

1. A cork handle used in a kitchen comprising:
an extension made of a traditional material and including at least one cork member.

2. The cork handle used in the kitchen as claimed in claim 1, wherein the extension includes at least one receiving groove; at least one cork member is retained in the receiving groove and exposes outsides the receiving groove.

3. The cork handle used in the kitchen as claimed in claim 2, wherein the cork handle includes an elongated extension, and the elongated extension includes two receiving grooves formed in two recessed areas of two sides thereof individually, the receiving groove includes a plurality of holes arranged on an inner surface thereof; and each of two cork members is formed in a thin piece shape and includes a number of orifices disposed thereon relative to the holes of the receiving groove so as to be retained in the receiving groove;
a plurality of fixing elements to be locked in the holes of the receiving groove through the orifices of the cork member individually so that the cork member is fixed in the receiving groove.

4. The cork handle used in the kitchen as claimed in claim 3, wherein the cork handle includes the extension which is elongated, and the extension includes the receiving groove formed in a recessed area of each of two sides thereof; and each of two cork members is formed in a thin piece shape to be retained in the receiving groove; two adhering pieces, each being located between an inner surface of the receiving groove and the cork member to adhere the cork member in the receiving groove.

5. The cork handle used in the kitchen as claimed in claim 3, wherein the receiving grooves include two peripheral walls extending toward two central positions thereof individually to form a decreasingly conical space; and the cork members include two peripheral walls tilting outward to form a wedge, such that the cork members are respectively retained in the receiving grooves tightly.

6. The cork handle used in the kitchen as claimed in claim 4, wherein the receiving grooves include two peripheral walls extending toward two central positions thereof individually to form a decreasingly conical space; and the cork members include two peripheral walls tilting outward to form a wedge, such that the cork members are respectively retained in the receiving grooves tightly.

7. The cork handle used in the kitchen as claimed in claim 2, wherein the cork handle includes an elongated extension, and the elongated extension includes an oblong receiving groove formed on a middle section thereof; a cork member is formed in an oblong shape and retained in the receiving groove.

8. The cork handle used in the kitchen as claimed in claim 2, wherein the cork members are connected with the extension in any one of a retaining, adhering, riveting, or screwing manner.

9. The cork handle used in the kitchen as claimed in claim 2, wherein the cork handle includes a flat extension, an aperture formed on one side of the cork member relative to the extension, the cork member is fitted with the extension by using the aperture.
